(19) United States
(12) Patent Application Publication
(10) Pub. No.: US 2007/0133810 A1
(43) Pub. Date: Jun. 14, 2007

(54) SOUND FIELD CORRECTION APPARATUS

(75) Inventors: Katsuhiro KISHI, Kanagawa (JP); Toshihiko Masuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Minato-ku (JP)

(21) Appl. No.: 11/557,650

(22) Filed: Nov. 8, 2006

(30) Foreign Application Priority Data
Nov. 11, 2005 (JP) 2005-327874

(51) Int. Cl. H04R 5/00

(52) U.S. Cl. 381/17

(57) ABSTRACT

A sound field correction apparatus that corrects a sound field characteristic by supplying a measurement signal used for measurement purposes to drive a plurality of speakers arranged at arbitrary positions to reproduce the measurement signal and receiving a collected sound signal obtained by collecting the sound reproduced from the plurality of speakers with a sound collector disposed at an arbitrary listening point is disclosed. The sound field correction apparatus includes: a measurement signal supplier, a receiver, a delay calculator, a sound pressure level difference calculator, a delay correction value calculator, and a gain correction value calculator.

### CROSS REFERENCES TO RELATED APPLICATIONS

The present invention contains subject matter related to Japanese Patent Application P2005-327874 filed in the Japanese Patent Office on Nov. 11, 2005, the entire contents of which being incorporated herein by reference.

### BACKGROUND OF THE INVENTION

1. Field of the Invention

The invention relates to a sound field correction apparatus for correcting the sound field characteristic of an audio system having a plurality of speakers to a desired sound field characteristic.

2. Description of the Related Art

As an audio system having a plurality of speakers for providing a high-quality sound field space, there is a so-called 5.1-channel surround system using three front speakers (left, center and right), two rear speakers (left and right) and one low-range speaker (subwoofer).

To optimize such a 5.1-channel surround sound field, it is necessary to arrange the six speakers at appropriate positions with reference to the listening point where a user himself/herself listens to the sound.

In general, however, an indoor environment where such a 5.1-channel surround acoustic apparatus is arranged has various factors that limit the layout of the speakers. Furthermore, it is difficult for the user to manually adjust the layout of the speakers and achieve their best positions.

Moreover, after the speakers have been arranged, depending on the relationship between the listening point and the positions of the speakers, it may be necessary to adjust the sound volume setting and the audio arrival time setting. That is, the user has to intuitively perform sound volume adjustment and delay adjustment for each of the speakers in a repetitive manner.

To solve such a problem, it is conceivable to use a measurement signal to cause each of the speakers to output a measurement sound, collect the sound by a dedicated microphone connected to a dedicated terminal of the apparatus body, and perform adjustment using the collected sound to achieve optimal sound volume and delay settings.

In such a case, however, it is necessary to provide the dedicated microphone and the dedicated microphone terminal.

Japanese Patent No. 2723001 and No. 3147618 are exemplified as related art documents.

### SUMMARY OF THE INVENTION

It is desirable to provide a sound field correction apparatus by which a desired sound field characteristic can be achieved neither with a dedicated microphone for collecting sound reproduced from a plurality of speakers that have received a measurement signal used for measurement purposes in order to obtain the desired sound field characteristic nor with a microphone connection terminal, a microphone amplifier and the like for the dedicated microphone.

According to an embodiment of the invention, there is provided a sound field correction apparatus that corrects a sound field characteristic by supplying a measurement signal used for measurement purposes to drive a plurality of speakers arranged at arbitrary positions to reproduce the measurement signal and receiving a collected sound signal obtained by collecting the sound reproduced from the plurality of speakers with a sound collector disposed at an arbitrary listening point The sound field correction apparatus includes a measurement signal supplier that supplies the measurement signal, a receiver that receives the collected sound signal, a delay calculator that calculates relative arrival time differences among the sounds traveling from the speakers to the sound collector by comparing the measurement signal with the collected sound signal, a sound pressure level difference calculator that calculates relative sound pressure level differences among the sounds that arrive at the sound collector from the speakers by comparing the measurement signal with the collected sound signal, a delay correction value calculator that calculates a delay correction value to be provided to each of the speakers based on the relative arrival time difference calculated by the delay calculator and a desired sound field characteristic, and a gain correction value calculator that calculates a gain correction value to be provided to each of the speakers based on the relative sound pressure level difference calculated by the sound pressure level difference calculator and the desired sound field characteristic.

The sound field correction apparatus according to the embodiment of the invention is configured to supply a measurement signal from the measurement signal supplier to drive the plurality of speakers to reproduce the measurement signal, use the receiver to receive a collected sound signal obtained by collecting the sound reproduced from the plurality of speakers with the sound collector disposed at the listening point, calculate relative arrival time differences and relative sound pressure level differences by comparing the supplied measurement signal with the received collected sound signal in the delay calculator and the sound pressure level difference calculator, and calculate delay correction values and gain correction values in the delay correction value calculator and the gain correction value calculator based on the resultant relative arrival time differences and relative sound pressure level differences as well as a desired sound field characteristic, it is possible to provide the desired sound field characteristic neither with a dedicated microphone for collecting the sound reproduced from the plurality of speakers that have received the measurement signal nor with a microphone terminal, a microphone amplifier and the like for the dedicated microphone.

### BRIEF DESCRIPTION OF THE DRAWINGS

FIG. 1 is a block circuit diagram showing the configuration of the sound field correction apparatus to which the invention is applied;

FIG. 2 shows a measurement signal supplied from the measurement signal supplier of the sound field correction apparatus to which the invention is applied;

FIG. 3 is a flowchart showing internal processes performed in an audio amplifier having the sound field correction apparatus to which the invention is applied;

FIG. 4 a block circuit diagram showing another configuration of the sound field correction apparatus to which the invention is applied; and

FIG. 5 is a flowchart showing processes performed in a server having the sound field correction apparatus to which the invention is applied.

### DESCRIPTION OF THE PREFERRED EMBODIMENTS

A sound field correction apparatus to which the invention is applied will be described below with reference to the drawings.

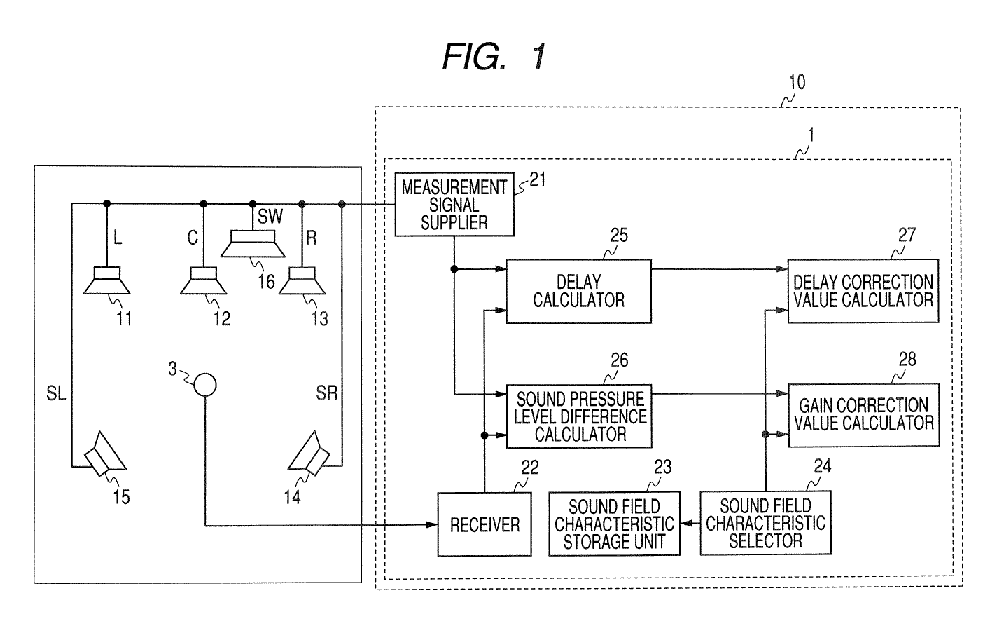

The sound field correction apparatus 1 to which the invention is applied, as shown in FIG. 1, corrects a sound field characteristic by supplying a measurement signal used for measurement purposes to drive a plurality of speakers 11 to 16 arranged at arbitrary positions to reproduce the measurement signal and receiving a collected sound signal obtained by collecting the sound reproduced from the plurality of speakers using a sound collector 3 disposed at a predetermined position, that is, an arbitrary listening point. In particular, the following description will be made assuming that the sound field correction apparatus 1 is provided in an audio amplifier 10.

The plurality of speakers 11 to 16 are arbitrarily arranged at predetermined positions in a room. The plurality of speakers 11 to 16 are typical speakers for reproducing audio and connected to the audio amplifier 10, for example, having a 5.1 multi-channel speaker output typically used for a home theater and the like.

The sound collector 3 used in this embodiment does not belong to the sound field correction apparatus, but is a separate existing portable instrument, such as a mobile phone, including a sound collecting portion that collects audio and a recording portion that records the collected sound result collected by the sound collecting portion. The sound collecting portion of the sound collector 3 used in this embodiment desirably has a non-directional characteristic.

The sound collector 3 is configured to have transmission means for transmitting the collected sound result recorded by the recording portion to a receiver 22 of the sound field correction apparatus 1, which will be described later, or configured to deliver the collected sound result recorded by the recording portion to the receiver 22 of the sound field correction apparatus 1 via a removable recording medium. The sound collector 3 is not limited to the mobile phone described above, but may be, for example, an IC recorder or a cassette tape recorder with a built-in microphone capability.

By configuring the sound field correction apparatus 1 to recognize the characteristic of the sound collecting portion of the sound collector 3, that is, the frequency response across the bandwidth of the measurement signal before actually collecting the sound, the collected sound signal can be more accurate.

The sound field correction apparatus 1 includes, as shown in FIG. 1, a measurement signal supplier 21 that supplies a measurement signal used for sound field correction to the plurality of speakers 11 to 16, and the receiver 22 that receives a collected sound signal obtained by using the sound collector 3 to collect the sound reproduced from the plurality of speakers 11 to 16 based on the supplied measurement signal.

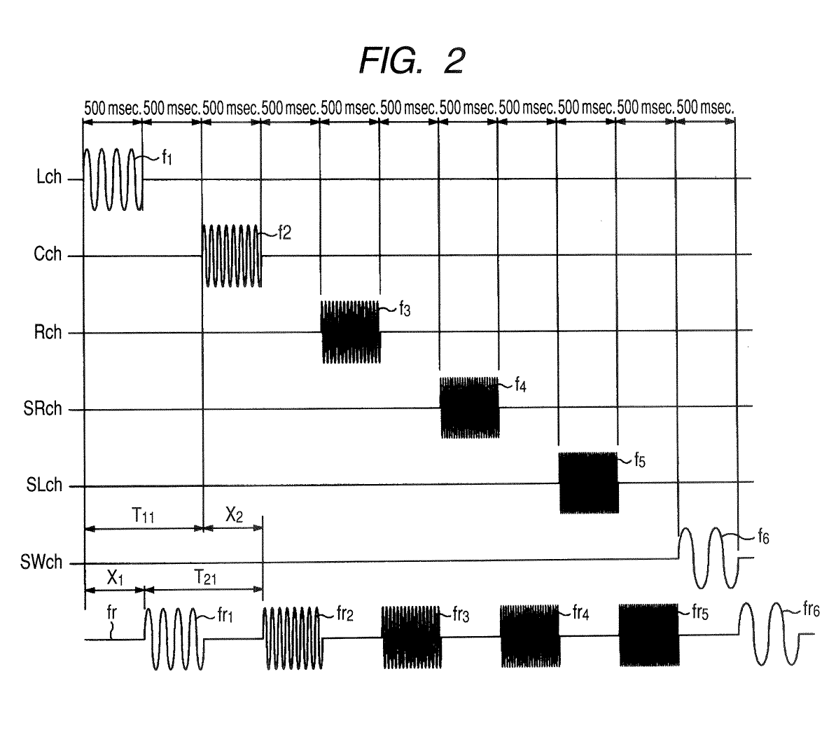

The measurement signal supplier 21 outputs a sinusoidal wave at a frequency predefined for each channel. That is, the measurement signal supplied from the measurement signal supplier 21 includes, as shown in FIG. 2, a first signal f1 for an L channel (Lch) that is supplied to the speaker 11 and has a first frequency of 250 Hz and a predetermined length of 500 msec, a second signal f2 for a C channel (Cch) that is supplied to the speaker 12 and has a second frequency of 500 Hz and a predetermined length of 500 msec with a silent period of a predetermined length of 500 msec following the end of the first signal, a third signal f3 for an R channel (Rch) that is supplied to the speaker 13 and has a third frequency of 1 kHz and a predetermined length of 500 msec with a silent period of a predetermined length of 500 msec following the end of the second signal, a fourth signal f4 for an SR channel (SRch) that is supplied to the speaker 14 and has a fourth frequency of 2 kHz and a predetermined length of 500 msec with a silent period of a predetermined length of 500 msec following the end of the third signal, a fifth signal f5 for an SL channel (SLch) that is supplied to the speaker 15 and has a fifth frequency of 4 kHz and a predetermined length of 500 msec with a silent period of a predetermined length of 500 msec following the end of the fourth signal, and a sixth signal f6 for an SW channel (SWch) that is supplied to the speaker 16 and has a sixth frequency of 63 Hz and a predetermined length of 500 msec with a silent period of a predetermined length of 500 msec following the end of the fifth signal.

Thus, the measurement signal supplied from the measurement signal supplier 21 is provided for a defined period for each channel, and the silent period that is an interval between a period when a signal is supplied to a channel and the next period when another signal is supplied to another channel is also a defined period. As described above with reference to the first to sixth signals f1 to f6, the output order of the signals is also predefined. The output order, the intervals and the frequencies described above are not limited thereto, but may be changed as appropriate.

A collected sound signal fr obtained by using the sound collector 3 to collect the sound reproduced from the speakers driven by the measurement signal formed of the first to sixth signals f1 to f6 includes, as shown in FIG. 2, signals fr1 to fr6 at respective frequencies as well as the silent periods therebetween. The collected sound signal fr obtained by using the sound collector 3 to actually collect the sound also includes delays resulting from the distances from the positions where the speakers 11 to 16 are disposed to the listening point where the sound collector 3 is provided. If the distances between the listening point and the positions where the speakers are disposed are all the same for all channels, the order of the signals outputted from the speakers and the silent periods remain unchanged in the collected sound signal. However, if the distance to at least one of the speakers differs from those to the other speakers, the length of the corresponding silent period will be changed.

Since the first to sixth signals f1 to f6 that are supplied from the measurement signal supplier 21 and outputted from the respective channels are outputted at different frequencies as described above, the signals fr1 to fr6 at respective frequencies in the collected sound signal fr that has been collected can be identified as corresponding to the respective channels. Therefore, it is possible to determine which channel is delayed or advanced, and which channel has a higher or lower level. That is, as will be described later, it is possible to calculate relative arrival time differences and relative sound pressure level differences among the sounds that are outputted from the speakers and collected at the listening point. Furthermore, since the signals are outputted at different frequencies, it is possible to reliably determine which channel has sent which signal even when the signals from the channels are superimposed in time in the collected sound signal fr.

The receiver 22 receives the collected sound signal fr, which is obtained by collecting the sound with the sound collector 3, by means of wireless communication, including infrared communication, Bluetooth, a wireless LAN (IEEE 802.11b/a/g) and a packet communication capability. Alternatively, the receiver 22 may be configured to receive the collected sound signal by means of wired communication via, for example, a USB cable or an audio cable. Still alternatively, the receiver 22 may be configured to receive the collected sound signal via a removable recording medium, such as a flash memory card on which the collected sound signal is recorded by the sound collector.

The sound field correction apparatus 1 further includes, as shown in FIG. 1, a sound field characteristic storage unit 23 that stores a plurality of sound field characteristics, and a sound field characteristic selector 24 that selects a desired sound field characteristic from the plurality of sound field characteristics stored in the sound field characteristic storage unit 23 based on an operation by the operator.

The sound field characteristic storage unit 23 stores sound field characteristics of optimal sound field spaces from which a sense of realism is provided, for example, various concert halls, movie theaters and the like, and can also store, if any, a preferred sound field characteristic that the user considers it as optimal. The sound field characteristic selector 24 can select a desired sound field characteristic from the plurality of sound field characteristics based on a user operation, and can also adjust the preferred sound field characteristic that the user considers it as optimal.

Although the sound field characteristic storage unit 23 and the sound field characteristic selector 24 are provided in the sound field correction apparatus 1 in this embodiment, the configuration is not limited thereto. For example, the sound field characteristic storage unit 23 and the sound field characteristic selector 24 may be provided in the audio amplifier 10.

The sound field correction apparatus 1 further includes, as shown in FIG. 1, a delay calculator 25 that calculates relative arrival time differences among the sounds traveling from the speakers 11 to 16 to the sound collector 3 by comparing the measurement signal with the collected sound signal, and a sound pressure level difference calculator 26 that calculates relative sound pressure level differences among the sounds that arrive at the sound collector 3 from the speakers 11 to 16 by comparing the measurement signal with the collected sound signal.

The delay calculator 25 calculates relative arrival time differences among the sounds traveling from the speakers 11 to 16 to the listening point where the sound collector 3 is disposed by comparing the measurement signal supplied from the measurement signal supplier 21 to the speakers 11 to 16 with the collected sound signal that is obtained by using the sound collector 3 to collect audio reproduced from the speakers 11 to 16 based on the measurement signal and received by the receiver 22. Specifically, the delay calculator 25 calculates the arrival time difference between the reference arrival time of the sound traveling from one speaker 11, which first reproduces the sound in response to the measurement signal, to the listening point and the arrival time of the sound traveling from each of the remaining speakers 12 to 16 to the listening point.

For example, as shown in FIG. 2, let T11 be the time difference between the start points of the waveforms of the first and second signals f1 and f2 supplied to the reference speaker 11 and the speaker 12, respectively, and let T21 be the time difference between the start points of the waveforms of the signals fr1 and fr2 at the respective frequencies in the collected sound signal fr obtained by collecting the sounds outputted from the speakers 11 and 12 with the sound collector 3. Then, the arrival time difference (X2−X1) between the arrival time X1 of the sound traveling from the speaker 11 to the listening point and the arrival time X2 of the sound traveling from the speaker 12 to the listening point can be calculated by the equation of (X2−X1)=T21−T11, because T11+X2=X1+T21, where the time difference T11 is a value determined by the measurement signal supplier 21 and is 1 second in this embodiment. Therefore, the difference between the time when the sound from the speaker 11 arrives at the sound collector 3 and the time when the sound from the speaker 12 arrives at the sound collector 3 can be calculated based on the time difference T11 and the time difference T21 that is calculated from the collected sound signal fr. The same applies to the other speakers 13 to 16.

The sound pressure level difference calculator 26 calculates relative sound pressure level differences among the sounds that arrive at the sound collector 3 disposed at the listening point from the speakers 11 to 16 by comparing the measurement signal supplied from the measurement signal supplier 21 to the speakers 11 to 16 with the collected sound signal that is obtained by using the sound collector 3 to collect the audio reproduced from the speakers 11 to 16 based on the measurement signal and received by the receiver 22. Specifically, the sound pressure level difference calculator 26 calculates the sound pressure level difference between the reference sound pressure level of the sound that arrives at the sound collector 3 from one speaker 11, which first reproduces the audio in response to the measurement signal and the sound pressure level of the sound that arrives at the sound collector 3 from each of the remaining speakers 12 to 16. The relative sound pressure level difference is calculated from the amplitudes of the measurement signal and the collected sound signal.

The sound field correction apparatus 1 further includes, as shown in FIG. 1, a delay correction value calculator 27 that calculates a delay correction value to be provided to each of the speakers based on the relative arrival time difference calculated by the delay calculator 25 and a sound field characteristic selected by the sound field characteristic selector 24, and a gain correction value calculator 28 that calculates a gain correction value to be provided to each of the speakers based on the relative sound pressure level difference calculated by the sound pressure level difference calculator 26 and the sound field characteristic selected by the sound field characteristic selector 24.

The delay correction value calculator 27 calculates a delay correction value to be provided to each of the speakers 11 to 16 by comparing ideal relative arrival time differences among the sounds that arrive at the listening point from the speakers with the actual relative arrival time differences in the indoor environment calculated by the delay calculator 25, where the ideal relative arrival time differences are necessary for providing the sound field characteristic selected by the sound field characteristic selector 24. When considering one reference speaker 11 and one of the remaining speakers, for example, the speaker 12, the delay correction value calculator 27 calculates a delay correction value for advancing or delaying the output timing of the sound from the speaker 12 such that the actual arrival time difference, which is the difference between the arrival time of the sound that arrives at the sound collector 3 from the speaker 11 and the arrival time of the sound that arrives at the sound collector 3 from the speaker 12, becomes the ideal arrival time difference necessary for providing a desired sound field characteristic.

The gain correction value calculator 28 calculates a gain correction value to be provided to each of the speakers 11 to 16 by comparing ideal relative sound pressure level differences among the sounds that arrive at the sound collector 3 disposed at the listening point from the speakers with the actual relative sound pressure level differences in the indoor environment calculated by the sound pressure level difference calculator 26, where the ideal relative sound pressure level differences are necessary for providing the sound field characteristic selected by the sound field characteristic selector 24. When considering one reference speaker 11 and one of the remaining speakers, for example, the speaker 12, the gain correction value calculator 28 calculates a gain correction value for increasing or decreasing the sound pressure level of the sound outputted from the speaker 12 such that the actual sound pressure level difference, which is the difference between the sound pressure level of the sound that is reproduced from the speaker 11 and arrives at the sound collector 3 and the sound pressure level of the sound that is reproduced from the speaker 12 and arrives at the sound collector 3, becomes the ideal sound pressure level difference necessary for providing the desired sound field characteristic

The sound field correction apparatus 1 thus configured can use the delay calculator 25, the sound pressure level difference calculator 26, the delay correction value calculator 27 and the gain correction value calculator 28 to provide the delay correction value and the gain correction value for providing the desired sound field characteristic based on the measurement signal supplied from the measurement signal supplier 21 and the collected sound signal obtained by using the sound collector 3 disposed outside to collect the sounds outputted from the speakers 11 to 16 that have received the measurement signal. The sound field correction apparatus 1 then uses the delay correction value and the gain correction value to make a delay setting and a gain correction setting for each of the speakers, that is, to modify the input-side frequency response that affects the output, allowing audio information with the desired sound field characteristic to be reproduced.

That is, the sound field correction apparatus 1 can set a reproducing environment and output reproduced sound adapted to the indoor environment. For example, it is possible to build an acoustic space adapted to a reverberation characteristic of a concert hall.

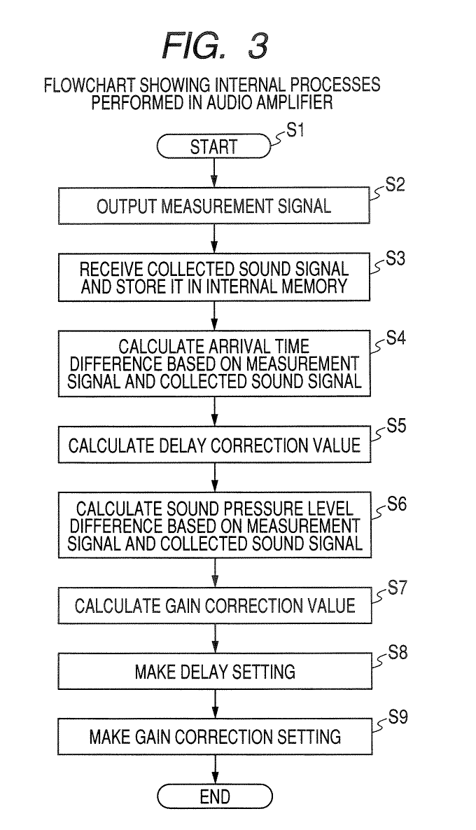

Next, with reference to FIG. 3, a description will be made of the procedure for indoor environment measurement, environment data transfer and sound field characteristic correction using the above-mentioned sound field correction apparatus 1 provided in the audio amplifier 10.

Firstly, the sound collector 3, such as a mobile phone, is installed at the listening point where the user actually listens to audio information reproduced from the speakers. Alternatively, the user may hold the sound collector 3 by hand. Then, the sound collecting portion of the sound collector 3 is activated to start collecting sound (S1).

When a start button provided on the audio amplifier 10 is pressed, the measurement signal supplier 21 of the sound field correction apparatus 1 supplies the measurement signal used for measurement purposes, such as the one shown in FIG. 2 described above, to the speakers 11 to 16 (S2).

The speakers 11 to 16 that have received the measurement signal output respective measurement sounds. The sound collector 3 collects the measurement sounds and records the measured sound result as the collected sound signal fr in the recording portion. The collected sound signal fr is then transferred to the receiver 22.

The receiver 22 receives the collected sound signal fr obtained by the sound collector 3 and stores it in an internal memory (S3).

In this process, the receiver 22 receives the collected sound signal via infrared communication, Bluetooth, a wireless LAN (IEEE 802.11b/a/g), a packet communication capability, a USB cable, an audio cable, a flash memory card or the like as described above.

The delay calculator 25 calculates relative arrival time differences among the sounds traveling from the speakers 11 to 16 to the sound collector 3 based on the supplied measurement signal and the received collected sound signal (S4).

The delay correction value calculator 27 calculates a delay correction value from each of the relative arrival time differences and the ideal arrival time difference necessary for providing a desired sound field characteristic (S5).

The sound pressure level difference calculator 26 calculates relative sound pressure level differences among the sounds that arrive at the sound collector 3 from the speakers 11 to 16 based on the supplied measurement signal and the received collected sound signal (S6).

The gain correction value calculator 28 calculates a gain correction value from each of the relative sound pressure level differences and the ideal sound pressure level difference necessary for providing the desired sound field characteristic (S7).

The audio amplifier 10 makes a delay setting for each of the speakers 11 to 16 using the resultant delay correction value (S8)

The audio amplifier 10 also makes a gain correction setting for each of the speakers 11 to 16 using the resultant gain correction value (S9).

The audio amplifier 10 for which the delay setting and the gain correction setting are made using the delay correction value and the gain correction value is now set such that the outputs from the speakers 11 to 16 are adjusted to provide an optimal sound field setting in which, for example, the arrival times and the sound pressure levels of audio from the channels are equal to each other. The thus set audio amplifier 10 drives each of the speakers 11 to 16 to output reproduced sound.

The sound field correction apparatus 1 to which the invention is applied can use the delay calculator 25, the sound pressure level difference calculator 26, the delay correction value calculator 27 and the gain correction value calculator 28 to provide a delay correction value and a gain correction value for providing a desired sound field characteristic based on the measurement signal supplied from the measurement signal supplier 21 and the collected sound signal obtained by using the sound collector 3 disposed outside to collect the sounds outputted from the speakers that have received the measurement signal. Therefore, the sound field correction apparatus 1 can provide the desired sound field characteristic neither with a dedicated microphone for collecting the sounds reproduced from the plurality of speakers that have received the measurement signal nor with a microphone connection terminal, a microphone amplifier and the like for the dedicated microphone.

As the sound collector for collecting sound generated by reproducing the measurement signal, the sound field correction apparatus 1 to which the invention is applied can use an existing external instrument, for example, a mobile phone, an IC recorder or a cassette tape recorder with a built-in microphone capability, and provide the desired sound field characteristic while simplifying the configuration of the sound field correction apparatus itself and the audio amplifier.

Although the sound field correction apparatus 1 has been described as provided in the audio amplifier 10, the configuration is not limited thereto. For example, when the audio amplifier having a multi-channel speaker output to a plurality of speakers and the sound collector for collecting the measurement sound are equipped with interfaces to a network, the sound field correction apparatus 1 may be provided in a server connected to the network.

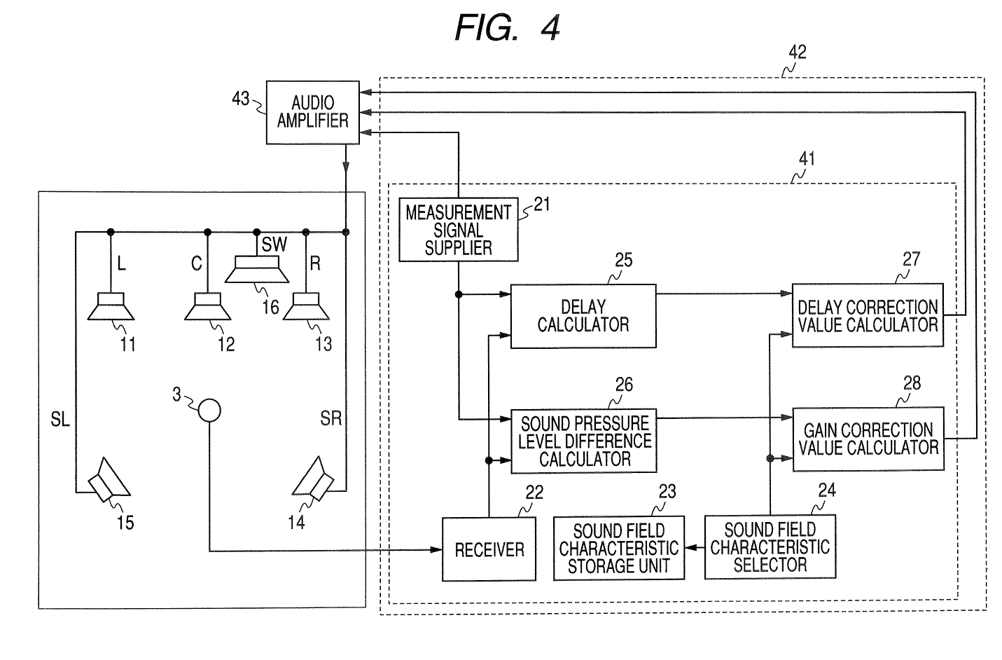

Next, a description will be made of a sound field correction apparatus 41 shown in FIG. 4 that is provided in a transmission server, calculates a delay correction value and a gain correction value in the server and sends the delay correction value and the gain correction value to an audio amplifier via a network. In the following description, common parts to the sound field correction apparatus 1 have common reference characters and detailed description thereof will be omitted.

The sound field correction apparatus 41 to which the invention is applied, as shown in FIG. 4, corrects a sound field characteristic by supplying a measurement signal used for measurement purposes to drive a plurality of speakers 11 to 16 arranged at arbitrary positions to reproduce the measurement signal and receiving a collected sound signal obtained by collecting the sound reproduced from the plurality of speakers using a sound collector 3 disposed at a predetermined position, that is, an arbitrary listening point. The sound field correction apparatus 41 is provided in a server 42 connected to a network.

The plurality of speakers 11 to 16 are connected to an audio amplifier 43 with a 5.1 multi-channel speaker output, as in the above embodiment. The audio amplifier 43 is connected to the server 42 via the network and receives the delay correction value and the gain correction value calculated as will be described later from the sound field correction apparatus 41 provided in the server 42.

In this embodiment, although data transfer between the sound collector 3 and the server 42 as well as data transfer between the server 42 and the audio amplifier 43 is performed via the network, the data transfer may be performed, for example, via a recording medium, such as a flash memory card. When the data transfer is performed using a flash memory card or the like, sound field correction, which will be described later, is possible without an environment connectable to a network.

The sound field correction apparatus 41 includes, as shown in FIG. 4, a measurement signal supplier 21 that supplies a measurement signal for sound field correction to the plurality of speakers 11 to 16 via the audio amplifier 43, a receiver 22 that receives a collected sound signal obtained by using the sound collector 3 to collect the sound reproduced from the plurality of speakers 11 to 16 based on the supplied measurement signal, a sound field characteristic storage unit 23 that stores a plurality of sound field characteristics, and a sound field characteristic selector 24 that selects a desired sound field characteristic from the plurality of sound field characteristics stored in the sound field characteristic storage unit 23 based on an operation by the operator.

Although the sound field characteristic storage unit 23 and the sound field characteristic selector 24 are provided in the sound field correction apparatus 41 in this embodiment, the configuration is not limited thereto. For example, the sound field characteristic storage unit 23 and the sound field characteristic selector 24 may be provided in the server 42 or the audio amplifier 43.

Although the measurement signal supplier 21 for supplying the measurement signal for sound field correction to the plurality of speakers 11 to 16 is provided in the sound field correction apparatus 41 that is provided in the server 42, the configuration is not limited thereto. For example, the measurement signal supplier 21 may be provided in the audio amplifier 43.

The sound field correction apparatus 41 further includes a delay calculator 25 that calculates relative arrival time differences among the sounds traveling from the speakers 11 to 16 to the sound collector 3 by comparing the measurement signal with the collected sound signal, a sound pressure level difference calculator 26 that calculates relative sound pressure level differences among the sounds that arrive at the sound collector 3 from the speakers 11 to 16 by comparing the measurement signal with the collected sound signal, a delay correction value calculator 27 that calculates a delay correction value to be provided to each of the speakers based on the relative arrival time difference calculated by the delay calculator 25 and a sound field characteristic selected by the sound field characteristic selector 24, and a gain correction value calculator 28 that calculates a gain correction value to be provided to each of the speakers based on the relative sound pressure level difference calculated by the sound pressure level difference calculator 26 and the sound field characteristic selected by the sound field characteristic selector 24.

The sound field correction apparatus 41 thus configured can use the delay calculator 25, the sound pressure level difference calculator 26, the delay correction value calculator 27 and the gain correction value calculator 28 to provide the delay correction value and the gain correction value for providing the desired sound field characteristic based on the measurement signal supplied from the measurement signal supplier 21 and the collected sound signal obtained by using the sound collector 3 disposed outside to collect the sounds outputted from the speakers 11 to 16 that have received the measurement signal. The sound field correction apparatus 41 then transmits the delay correction value and the gain correction value to the audio amplifier 43, which then uses these correction values to make a delay setting and a gain correction setting for each of the speakers, that is, to modify the input-side frequency response that affects the output, allowing audio information with the desired sound field characteristic to be reproduced.

That is, the sound field correction apparatus 41 can set a reproducing environment and output reproduced sound adapted to the indoor environment. For example, it is possible to build an acoustic space adapted to a reverberation characteristic of a concert hall.

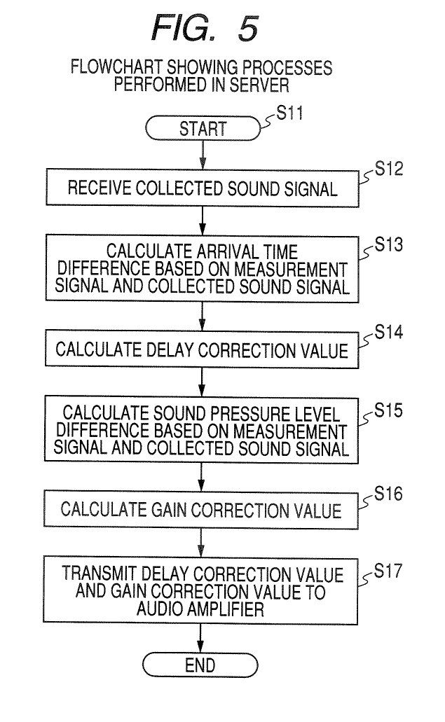

Next, with reference to FIG. 5, a description will be made of the procedure for indoor environment measurement, environment data transfer and sound field characteristic correction using the above-mentioned sound field correction apparatus 41 provided in the server 42.

Firstly, the sound collector 3 is installed at the listening point where a user actually listens to audio information reproduced from the speakers. Alternatively, the user may hold the sound collector 3 by hand. Then, the sound collecting portion of the sound collector 3 is activated to start collecting sound (S11).

When a start button provided on the audio amplifier 43 is pressed, the measurement signal supplier 21 of the sound field correction apparatus 41 supplies the measurement signal used for measurement purposes to the speakers 11 to 16 via the audio amplifier 43. The speakers 11 to 16 that have received the measurement signal output respective measurement sounds. The sound collector 3 collects the measurement sounds and records the measured sound result as the collected sound signal fr in the recording portion. The collected sound signal fr is then transferred to the server 42 via the network.

The receiver 22 of the sound field correction apparatus 41 provided in the server 42 receives the collected sound signal (S12).

The delay calculator 25 calculates relative arrival time differences among the sounds traveling from the speakers 11 to 16 to the sound collector 3 based on the supplied measurement signal and the received collected sound signal (S13).

The delay correction value calculator 27 calculates a delay correction value from each of the relative arrival time differences and the ideal arrival time difference necessary for providing a desired sound field characteristic (S14).

The sound pressure level difference calculator 26 calculates relative sound pressure level differences among the sounds that have arrived at the sound collector 3 from the speakers 11 to 16 based on the supplied measurement signal and the received collected sound signal (S15).

The gain correction value calculator 28 calculates a gain correction value from each of the relative sound pressure level differences and the ideal sound pressure level difference necessary for providing the desired sound field characteristic (S16).

The server 42 transmits the resultant delay correction values and gain correction values to the audio amplifier 43 via the network (S17).

The audio amplifier 43 makes a delay setting and a gain correction setting for each of the speakers 11 to 16 based on the delay correction value and the gain correction value, and is now set such that the outputs from the speakers 11 to 16 are adjusted to provide an optimal sound field setting in which, for example, the arrival times and the sound pressure levels of audio from the channels are equal to each other. The thus set audio amplifier 43 drives each of the speakers 11 to 16 to output reproduced sound.

The sound field correction apparatus 41 to which the invention is applied is provided in the server 42 and can use the delay calculator 25, the sound pressure level difference calculator 26, the delay correction value calculator 27 and the gain correction value calculator 28 to provide a delay correction value and a gain correction value for providing a desired sound field characteristic based on the measurement signal supplied from the measurement signal supplier 21 and the collected sound signal obtained by using the sound collector 3 disposed outside to collect the sounds outputted from the speakers that have received the measurement signal. Therefore, by transferring these correction values to the audio amplifier 43 via the network, the sound field correction apparatus 41 can provide the desired sound field characteristic neither with a dedicated microphone for collecting sounds reproduced from the plurality of speakers that have received the measurement signal nor with a microphone connection terminal, a microphone amplifier and the like for the dedicated microphone.

As the sound collector for collecting sound generated by reproducing the measurement signal, the sound field correction apparatus 41 to which the invention is applied can use an existing external instrument, for example, a mobile phone, an IC recorder or a cassette tape recorder with a built-in microphone capability, and provide the desired sound field characteristic while simplifying the configuration of the sound field correction apparatus itself and the audio amplifier.

The sound field correction apparatus 41 to which the invention is applied is configured to be provided in the server 42 and calculate the delay correction value and the gain correction value on a DSP in the server 42, thus reducing the calculation load on a DSP in the audio amplifier 43 and allowing more precise analysis of the indoor environment and more precise sound field correction.

Since the sound field correction apparatus 41 to which the invention is applied is configured to calculate the delay correction value and the gain correction value in the server 42, it is possible to increase the types of sound field characteristics to be selected, add or deliver a sound field characteristic as a new acoustic environment, accumulate sound field characteristics set by a plurality of users and share the sound field characteristics among the users.

It should be understood by those skilled in the art that various modifications, combinations, sub-combinations and alterations may occur depending on design requirements and other factors insofar as they are within the scope of the appended claims or the equivalents thereof.

What is claimed is:

1. A sound field correction apparatus that corrects a sound field characteristic by supplying a measurement signal used for measurement purposes to drive a plurality of speakers arranged at arbitrary positions to reproduce the measurement signal and receiving a collected sound signal obtained by collecting the sound reproduced from the plurality of speakers with a sound collector disposed at an arbitrary listening point, the sound field correction apparatus comprising:
a measurement signal supplier that supplies the measurement signal;
a receiver that receives the collected sound signal;
a delay calculator that calculates relative arrival time differences among the sounds traveling from the speakers to the sound collector by comparing the measurement signal with the collected sound signal;
a sound pressure level difference calculator that calculates relative sound pressure level differences among the sounds that arrive at the sound collector from the speakers by comparing the measurement signal with the collected sound signal;
a delay correction value calculator that calculates a delay correction value to be provided to each of the speakers based on the relative arrival time difference calculated by the delay calculator and a desired sound field characteristic, and;
a gain correction value calculator that calculates a gain correction value to be provided to each of the speakers based on the relative sound pressure level difference calculated by the sound pressure level difference calculator and the desired sound field characteristic.

2. The sound field correction apparatus according to claim 1, wherein a sound collecting portion of the sound collector recognizes the frequency response across the bandwidth of the measurement signal in advance.

3. The sound field correction apparatus according to claim 1, wherein the measurement signal supplier that supplies the measurement signal outputs a signal at a predefined frequency for each of the speakers.

4. The sound field correction apparatus according to claim 3, wherein the measurement signal supplier that supplies the measurement signal alternately starts and stops sending the measurement signal at a predefined time interval for each of the speakers.

5. The sound field correction apparatus according to claim 4, wherein the measurement signal is formed of multiple frequencies and has output periods of 500 msec and suspended periods of 500 msec repeatedly arranged.

6. A sound field correction apparatus that corrects a sound field characteristic by supplying a measurement signal used for measurement purposes to drive a plurality of speakers arranged at arbitrary positions to reproduce the measurement signal and receiving a collected sound signal obtained by collecting the sound reproduced from the plurality of speakers with a sound collector disposed at an arbitrary listening point, wherein the sound collector that is disposed at the arbitrary listening point and collects the measurement signal reproduced from the plurality of speakers has a built-in microphone.
